(19) United States
(12) Patent Application Publication
(10) Pub. No.: US 2005/0207351 A1
(43) Pub. Date: Sep. 22, 2005

(54) Receiver and receiving method, and communication system and communication device

(75) Inventor: Osamu Inagawa, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/083,026

(22) Filed: Mar. 18, 2005

(30) Foreign Application Priority Data
Mar. 19, 2004 (JP) 2004-080911

(51) Int. Cl. H04L 12/26; H04B 7/216

(52) U.S. Cl. 370/252; 370/335; 370/342

(57) ABSTRACT

Disclosed is a receiver which receives a signal composed of a plurality of symbols and performs despreading in time domain. The plurality of symbols are obtained by spreading one symbol in time domain on a transmitting side, and are sequentially sent out on a transmission channel by switching carrier frequencies according to a predetermined hopping pattern. The receiver includes a measurement circuit 4 for measuring signal qualities of the plurality of symbols for the one transmission symbol, a weight determination circuit 5 for inputting the signal qualities of the plurality of symbols to derive weight factors for the plurality of symbols, and a combining circuit 6 for outputting the symbol obtained by weighted addition of the plurality of symbols received, using the weight factors for the plurality of symbols determined by the weight determination circuit.

### FIELD OF THE INVENTION

The present invention relates to a communication device. More specifically, the invention relates to a receiver and the communication device equipped with the receiver suitable for being applied to communication that performs spreading in time domain.

### BACKGROUND OF THE INVENTION

Recently, in addition to wireless communication using cell phones and a wireless LAN (Local Area Network), practical application of a wireless personal area network (Wireless Personal Area Network; WPAN) for performing small-scale wireless communication among household devices, and devices (such as digital cameras) for transmitting various digital contents has been diligently studied by an IEEE 802.15 Working Group for WPAN TG3a (Task Group 3a WPAN at High rate PHY) or the like, for example. In the WPAN, in order to be applied to transmission of multimedia information, for example, speeding up and high reliability of information transmission are demanded, and measures against noise, interference, or the like caused by communication from other WPAN devices or the like is also required.

OFDM (Orthogonal Frequency Division Multiplexing), which has high frequency efficiency and multi-path tolerance and of which application to the WPAN has been studied, is a type of multi-carrier transmission, and frequencies of a plurality of subcarriers (with sine waves) that constitute an OFDM symbol are set so that the subcarriers are orthogonal to one another within one symbol interval. Generation of an OFDM signal is performed by an Inverse Fast Fourier transform (IFFT) for the amplitude and phase of each subcarrier. On the other hand, demodulation is carried out by a Fast Fourier transform (FFT). It is also a characteristic of the OFDM that the influence of inter-code interference is reduced by setting a guard interval in the symbol segment. Then, various proposals are made about a communication method as well for switching a carrier frequency according to a predetermined hopping pattern, for information transmission (which is also referred to as “multi-band OFDM”) (refer to Non-patent Document 1, for example, which will be described later).

The multi-band OFDM for performing the spreading in time domain (Time domain spreading or Time Spreading) so as to achieve high reliability will be described below. As shown in FIG. 9A, in a certain piconet (which will be referred to as a “piconet A”), a symbol generated by the same information bits is transmitted twice, for example, for each symbol segment that constitutes an information transmission unit by hopping carrier frequencies. In this case, the rate of time spreading rate (time spreading rate) is set to two. As shown in FIG. 9A, carrier frequency hopping patterns in the piconet A are cyclically repeated with each cycle constituted from f1, f2, and f3, such as f1, f2, f3, f1, f2, f3, . . . . In frequency bands f1 and f2, one transmission symbol A1 (OFDM symbol) is transmitted twice consecutively in the form of symbols A1-1 and A1-2. Meanwhile, a network formed with a master (a base unit) and slaves (slave units) connected in adhoc manner is referred to as a piconet.

Further, as shown in FIG. 9B, in other piconet (which will be referred to as a “piconet B”), carrier frequency hopping patterns are cyclically repeated with each cycle constituted from (f3, f2, and f1), such as f3, f2, f1, f3, f2, f1, . . . . If communication between devices (such as the master and two of the slaves) is performed using the hopping patterns in FIGS. 9A and 9B, respectively, the symbol A1-2 will collide with the symbol B1-2, and the symbol A3-1 will collide with the symbol B3-1, in the frequency band f2, as shown in FIG. 9C (refer to Non-patent Document 2, for example, which will be described later). As will be described later, when two symbols collide with each other in the same frequency band, reliability information (signal quality) of the received symbols of a receiver that receives these will deteriorate.

Next, processing of despreading in time domain (termed time despreading) will be described. FIG. 10 is a diagram schematically showing a configuration of a time domain despreader, in a multi-band OFDM receiver. The receiver receives the two symbols A1-1 and A1-2, for demodulation. The two symbols A1-1 and A1-2 are transmitted on a wireless transmission channel by spreading of one symbol A1 in time domain by a transmitter not shown. The despreader takes the symbol A1-1 and the symbol A1-2 corresponding to one transmission symbol A1, which have been received and then added by an adder 3, as the symbol A1 after the despreading.

In such a configuration, when frequency hopping patterns collide with each other (refer to FIG. 9C), for example, the gain of the despreading cannot be obtained. Further, an SNR (Signal to Noise ratio), which indicates the quality of the signal of the symbol A1 obtained by the despreading becomes worse than the better value of the SNRs of the two symbols A1-1 and A1-2. The SNR of a received signal is used as the reliability information in the communication environment of the transmission channel.

FIGS. 11A and 11B are schematic diagrams prepared for explaining the relationship between the SNRs of demodulated symbols in the piconet A and the SNRs of symbols obtained by the despreader in FIG. 10 (the SNRs of the outputs of the adder 3). Since the symbol A1-2 collides with the symbol B1-2 and the symbol A3-1 collides with the symbol B3-1 in the frequency band f2, the SNRs of the symbols in the frequency band f2 will become extremely worse than the SNRs of the received symbols in other frequency bands, at a receiver. That is, as shown in FIG. 11A, the SNRs of the received symbols A1-1, A1-2 (which has collided with the symbol B1-2), A2-1, A2-2, A3-1 (which has collided with the symbol B3-1), and A3-2 are “good”, “bad”, “good”, “good”, “bad”, and “good”, respectively. The SNRs of the symbols A1 and A2 and A3 after the despreading by the despreader in FIG. 10 become “bad”, “best”, and “bad”, respectively, as shown in FIG. 11B.

FIG. 12 is a graph that plots the SNR of the output of the adder 3 (=SA1+SA2) in FIG. 10, in a case wherein symbols input to the despreader in FIG. 10 are set to SA1 and SA2, respectively. Meanwhile, FIG. 12 is prepared by the present inventor based on the calculation (simulation) for explaining the problem of the convention configuration of FIG. 10. Referring to FIG. 12, the symbol SA1 and the symbol SA2 are the symbols received as the first symbol A1-1 and the second symbol A1-2 obtained by spreading of one symbol A1 in time domain, respectively, and then demodulated. The SNR of the symbol SA1 is fixed at 0 dB, while the SNR of the symbol SA2 is changed from 0 dB to 25 dB. The SNR is given by 10×log(S_{AV}/N_{AV})(in which the S_{AV} is the average power of a signal (symbol), while the N_{AV} is the average power of noise). When the SNRs of the symbols SA1 and SA2 are both 0 dB, the SNR of the output of the adder 3 in FIG. 10 is set to 10×log(2)≈3(dB). As shown in FIG. 12, even if the SNR of the symbol SA2 becomes 15 dB and 20 dB, for example, the SNR of the combined value of the two symbols SA1 and SA2 (=SA1+SA2) is approximately 6 dB. More specifically, when a difference between the SNRs of the symbol SA2 and the symbol SA1 is approximately 5 dB or larger, the SNR of the symbol output from the adder 3 in FIG. 10 deteriorates more than the SNR of the symbol SA2.

[Non-Patent Document 1]

doc: IEEE 802. 15/267r2 Project; IEEE P802. 15 Working Group for Wireless Personal Area Networks (WPANGSs), Slide 10, Slide 23, file “03267r2P802-15_TG3a-Multi-band-OFDM-CFP-Presentation.ppt” file for directory 2003/Jul03/at Internet <URL>http://grouper.ieee.org/groups/802/15/pub/.

[Non-Patent Document 2]

doc: IEEE 802. 15/343r1 Project; IEEE P802.15 Working Group for Wireless Personal Area Networks (WPANGSs), Slides 69-72, “15-03-0343-01-003a-multi-band-ofdm-sep03-presentation.pdf” file obtained from “2003-802 Wireless World Documents” at Internet <URL>http://grouper.ieee.org/groups/802/15/pub/Download.html.

### SUMMARY OF THE DISCLOSURE

By the way, in addition to the case where the carrier frequency hopping patterns collide with each other as shown in FIG. 9C, there are various factors of the reason for deterioration of the SNR for each symbol as shown in the result of demodulation in FIGS. 11A and 11B. They are, for example, extraneous noise, fading, the deterioration during a process for frequency domain equalization (FEQ) in a receiver, and the like. Among these, referring to the extraneous noise, when a device employs a specific frequency band among frequency bands used for a UWB (Ultra Wide Band), for example, the frequency band becomes noise (an interference wave) for other device, so that the SNRs of the signals in this frequency band will deteriorate for the other device.

Further, in a multi-path environment, signals (electrical waves), which have been transmitted from the same transmitting point, will pass through various paths and will be varied due to reflection, diffraction, and the like. Then, a signal obtained by combining these waves (a multiplexed wave) will be received at a receiving point. According to a difference among the lengths of paths through which the signals have passed, the strengths and the phases of the respective waves will differ, so that there are generated locations where the strengths and the phases are weakened or strengthened. The received field strength level will be therefore varied greatly and intricately (such a variation in the received field strength level will be referred to as “fading”). Then, due to the fading, it sometimes happens that a band has a frequency characteristic.

Further, there are some cases in which the SNR of a symbol obtained by the process of despreading in time domain deteriorates due to a frequency domain equalizer (FEQ). As will be described later, at the frequency domain equalizer (FEQ) for equalizing an OFDM data symbol demodulated by the FFT in frequency domain, a training signal (that is constituted from a signal in a preamble section at the leading edge of a packet, for example, and is also referred to as a “pilot symbol”) is used to perform estimation of a compensating coefficient for the FEQ (a tap compensating coefficient). However, if the estimation of the compensating coefficient for the FEQ is performed erroneously due to noise mixed into the preamble section, the SNR of a received signal in the frequency band for which the erroneous estimation has been performed will deteriorate.

When assignment of the carrier frequency hopping patterns is scheduled and managed by a transmitting side so as to avoid a frequency hopping pattern collision among a plurality of piconets, for example, the size of a circuit configuration is increased, generally. Further, together with an increase in the number of piconets, scheduling control for achieving avoidance of the collision will become complicated.

Further, even when the transmitting side uses the configuration in which the collision among the frequency hopping patterns is avoided, problems as follows still remain unsolved:
(A) the problem that the SNR of a frequency band deteriorates because the frequency band is used by other device and becomes an interference wave for a certain device and the SNR of a despread symbol therein deteriorates, and
(B) the problem of deterioration of the SNR of a despread symbol caused by frequency fading and an estimated error of the compensating coefficient for the FEQ

For this reason, in the cases of the (A) and (B) described above, even if the SNR of one symbol spread in time domain is good, due to the other symbol of which the SNR has deteriorated, deterioration of the SNR of the one symbol despreaded by the time domain despreader in FIG. 10 cannot not be avoided.

The present invention disclosed in the present application has a general configuration described below.

A receiver in accordance with one aspect of the present invention, which receives a plurality of symbols sent out from a transmitter executing, for information transmission, spreading of one symbol in time domain to obtain said plurality of symbol, includes a time domain despreading circuit for deriving weight factors for the plurality of symbols received based on respective reliability information of the plurality of symbols, and combining the plurality of symbols into one symbol based on the weight factors to output the combined one symbol.

In the present invention, the plurality of symbols may be sequentially sent out to a transmission channel from the transmitter which transmits the plurality of symbols by switching carrier frequencies according to a predetermined hopping pattern, and the receiver switches a local oscillation frequency corresponding to the hopping pattern used by the transmitter, for demodulation.

In the present invention, the time domain despreading circuit may include:
a measurement circuit for measuring the respective reliability information of the plurality of symbols;
a weight determination circuit for inputting the respective reliability information of the plurality of symbols to determine the weight factors for the plurality of symbols; and
a combining circuit for performing the combination the plurality of symbols into the one symbol, for output, based on the weight factors for the plurality of symbols.

Preferably, in the present invention, the weight factors for the plurality of symbols are determined so that reliability information of the one symbol obtained by the combining by the combining circuit becomes best.

In the present invention, the measurement circuit preferably measures signal qualities of the symbols as the respective reliability information of the symbols.

In the present invention, the combining circuit may include:
at least one multiplier for inputting each of the plurality of symbols and each of the weight factors from the weight determination circuit to multiply each of the input symbols by each of the weight factors corresponding to the symbols; and
an adder for inputting a result of the multiplication by the multiplier, for addition, and outputting a result of the addition as the combined one symbol.

In the present invention, the weight determination circuit may set the weight factors for the plurality of symbols to values proportional to measurement values of the signal qualities of the plurality of symbols.

In the present invention, the weight determination circuit may set the respective weight factors for the plurality of symbols so that when a difference of the signal quality measurement value of at least one of the plurality of symbols (such as the symbol having the best signal quality measurement value) and the signal quality measurement values of other ones of the plurality of symbols is a predetermined value or more in view of a magnitude relation among the signal quality measurement values of the plurality of symbols, at least one of the plurality of symbols is selected, and other ones of the plurality of symbols other than the selected symbol are not selected.

In the present invention, when a difference between the signal quality measurement values of two of the plurality of symbols is less than a predetermined value, or when the number of the plurality of symbols is two or more and the maximum value of differences among the signal quality measurement values of the plurality of symbols is less than the predetermined value in view of a magnitude relation among the signal quality measurement values of the plurality of symbols, the weight determination circuit may set the weight factors for the respective symbols to values proportional to the signal quality measurement values of the respective symbols.

In the present invention, when a difference between the signal quality measurement values of two of the plurality of symbols is less than a predetermined value, or when the number of the plurality of symbols is two or more and the maximum value of differences among the signal quality measurement values of the plurality of symbols is less than the predetermined value in view of a magnitude relation among the signal quality measurement values of the plurality of symbols, the weight determination circuit may set the weight factors for the plurality of symbols to be equal.

In the present invention, the weight determination circuit may set the respective weight factors for the plurality of symbols so that when a difference between signal quality measurement values of at least one of the plurality of symbols and other ones of the plurality of symbols is a predetermined value or more, in view of a magnitude relation among the signal quality measurement values of the plurality of symbols, at least one of the plurality of symbols is selected, and other ones of the plurality of symbols other than the selected symbol are not selected; and
when a difference between the signal quality measurement values of two of the plurality of symbols is less than the predetermined value or when the number of the plurality of symbols is two or more and the maximum value of differences among the signal quality measurement values of the plurality of symbols is less than the predetermined value, the weight determination circuit may set the weight factors for the plurality of symbols to be equal.

In the present invention, the signal qualities may be each constituted from the signal to noise ratio of a received signal.

A receiver in accordance with another aspect of the present invention, which receives a plurality of symbols sent out from a transmitter executing, for information transmission, spreading of one symbol in time domain to obtain said plurality of symbol, includes a time domain despreading circuit for selecting at least one of the plurality of symbols based on respective reliability information of the plurality of symbols received, and outputting the one symbol selected from among the plurality of symbols.

In the present invention, the time domain despreading circuit may includes:
a measurement circuit for measuring the respective reliability information of the plurality of symbols;
a selection control circuit for inputting the respective reliability information of the plurality of symbols and outputting selection control signals for controlling selection or non-selection of the respective plurality of symbols;
a plurality of selection switches for performing switching control of selection or non-selection of the respective plurality of symbols based on the selection control signals for the respective plurality of symbols; and
an addition circuit for performing addition in regard to the plurality of selection switches to output one symbol.

In the present invention, the measurement circuit preferably measures signal qualities (such as the signal to noise ratios) of the plurality of symbols as the respective reliability information of the plurality of symbols.

A communication system according to still another aspect of the present invention includes:
a transmitter for transmitting a plurality of symbols obtained by time spreading one symbol in time domain for information transmission; and
the receiver according to any one of the aspects of the present invention described above.

Preferably, the transmitter transmits the plurality of symbols by switching carrier frequencies according to a predetermined hopping pattern. In the present invention, the transmitter and the receiver may be of course included in the same equipment.

In a method according to still other aspect of the present invention, for receiving a plurality of symbols corresponding to one symbol and sent out from a transmitting side and despreading the plurality of symbols in time domain, the plurality of symbols obtained by spreading the one symbol in time domain for information transmission, the method includes the steps of:
(A) obtaining reliability information of the plurality of symbols;
(B) determining weight factors for the respective plurality of symbols based on the respective reliability information of the plurality of symbols received; and
(C) combining the plurality of symbols into one symbol based on the weight factors corresponding to the plurality of symbols, for output.

At the step (B) of determining the weight factors in the method according to the present invention, preferably, the weight factors for the plurality of symbols are set so that reliability information of the one symbol obtained by combining the plurality of symbols becomes best.

In a receiving method according to other aspect of the present invention, for receiving a plurality of symbols corresponding to one symbol and sent out from a transmitting side and despreading the plurality of symbols in time domain, the plurality of symbols obtained by spreading the one symbol in time domain for information transmission, the receiving method includes the steps of:
(A) obtaining reliability information of the plurality of symbols; and
(B) selecting at least one of the plurality of symbols based on the reliability information of the plurality of symbols, and outputting the selected one symbol from among the plurality of symbols.
   In the method according to the present invention, the plurality of symbols is sequentially sent out from the transmitting side to a transmission channel by switching carrier frequencies in accordance with a predetermined hopping pattern.

The meritorious effects of the present invention are summarized as follows.

According to the present invention, during the despreading process of a symbol that has been spread in time domain, even in the case where the signal quality of at least one symbol is good, degrading of the signal quality of the symbol after the despreading process can be avoided.

Further, according to the present invention, by providing a switch for controlling selection of a symbol instead of a multiplier, the device configuration is simplified, thus contributing to downsizing and lower power dissipation.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram for explaining a configuration of an embodiment of the present invention;

FIG. 2 is a flow chart for explaining a processing procedure in the embodiment of the present invention;

FIG. 3 is a diagram for explaining an operation of the embodiment of the present invention;

FIG. 4 is a diagram for explaining a configuration of other embodiment of the present invention;

FIG. 5 is a diagram showing a configuration of an embodiment in which the present invention is applied to an MB-OFDM receiver;

FIG. 6 is a diagram for explaining measurement by an SNR measurement circuit in FIG. 5;

FIG. 7 is a diagram showing a configuration of an embodiment of an MB-OFDM transmitter;

FIG. 8 is a graph for quantitively explaining an effect and operation of the embodiment of the present invention;

FIGS. 9A, 9B and 9C include diagrams for explaining a communication method in which time spreading is performed after frequency hopping;

FIG. 10 is a diagram for explaining the time despreading;

FIGS. 11A and 11B include diagrams for explaining an operation of a time despreader shown in FIG. 10;

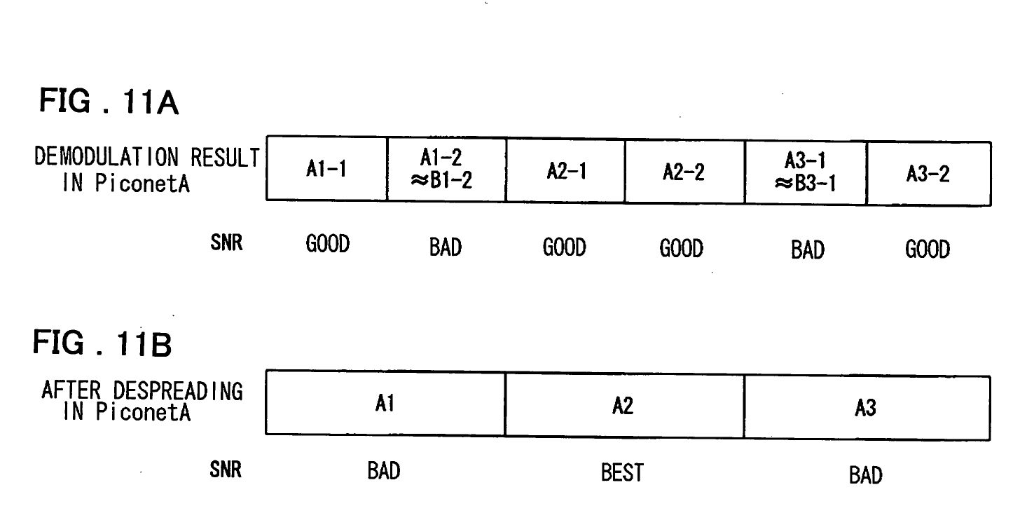

FIG. 12 is a graph quantitively showing an operation of the time despreader shown in FIG. 10; and

FIG. 13 is a diagram for explaining an example of a variation of the embodiment of the present invention.

### PREFERRED EMBODIMENTS OF THE INVENTION

The present invention will be described below with reference to the appended drawings so as to describe the invention in further detail.

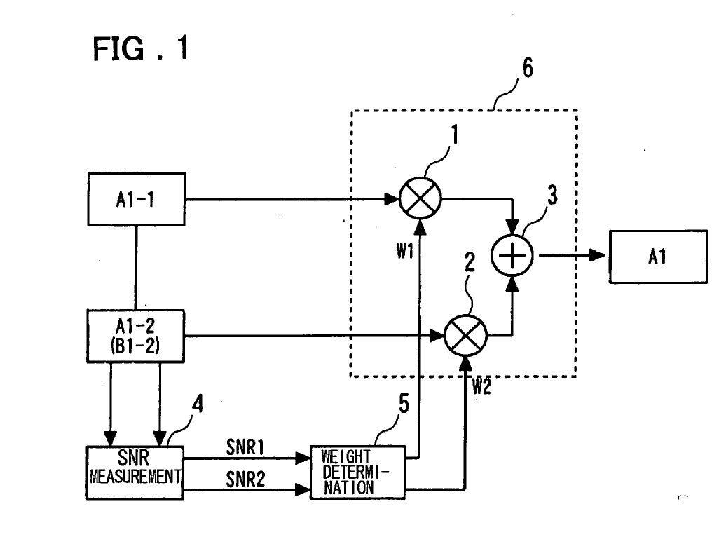

FIG. 1 is a diagram for explaining an embodiment for carrying out the present invention. In a communication device according to the embodiment of the present invention, a receiver receives a signal according to a communication protocol in which a plurality of symbols is sequentially transmitted on a wireless transmission channel by switching carrier frequencies in accordance with a predetermined hopping pattern. The plurality of symbols are obtained by spreading one symbol in time domain by a transmitter so as to perform information transmission. The receiver includes a time domain despreading circuit for despreading the plurality of symbols received in time domain. This time domain despreading circuit includes a measurement circuit 4 for obtaining reliability information of the plurality of symbols received, corresponding to one transmission symbol, a weight determination circuit 5 for deriving a weight factor for each of the plurality of symbols based on the reliability information of the symbols, and a combining circuit 6 for performing combining to obtain one symbol based on the weight factors (W1 and W2) for the plurality of symbols and the respective plurality of symbols (A1-1, A1-2) spread in time domain.

The measurement circuit 4 for obtaining the reliability information of the plurality of symbols spread in time domain measures signal quality such as the SNR (signal-to-noise ratio) of a symbol as the reliability information of the symbol (thus the reliability information of a transmission channel).

The combining circuit 6 includes a first multiplier 1 for multiplying a first symbol (A1-1) by a first weight factor (W1) corresponding to the first symbol to output the result of multiplication, a second multiplier 2 for multiplying a second symbol (A1-2) by a second weight factor (W2) corresponding to the second symbol to output the result of multiplication, and an adder 3 for adding the output of the first multiplier 1 to the output of the second multiplier 2, for output. In this embodiment, it is assumed that the weight factor W1 and W2 are normalized to satisfy the relation of W1+W2=1, for example. However, if W1+W2=N (N>1) holds, a divider for dividing the result of addition by the adder 3 by N may also be included. Incidentally, FIG. 1 shows a case in which a time spreading rate is two (one symbol is spread into two symbols in time domain), for simplicity. The present invention, however, is not of course limited to this configuration. In the case of the time spreading ratio being M (in which M is an integer of three or more) as well, M multipliers are juxtapositioned. Then, by inputting the outputs of the M multipliers into the adder and setting M weight factors to W1+W2+ . . . +WM=1, the same configuration can be obtained.

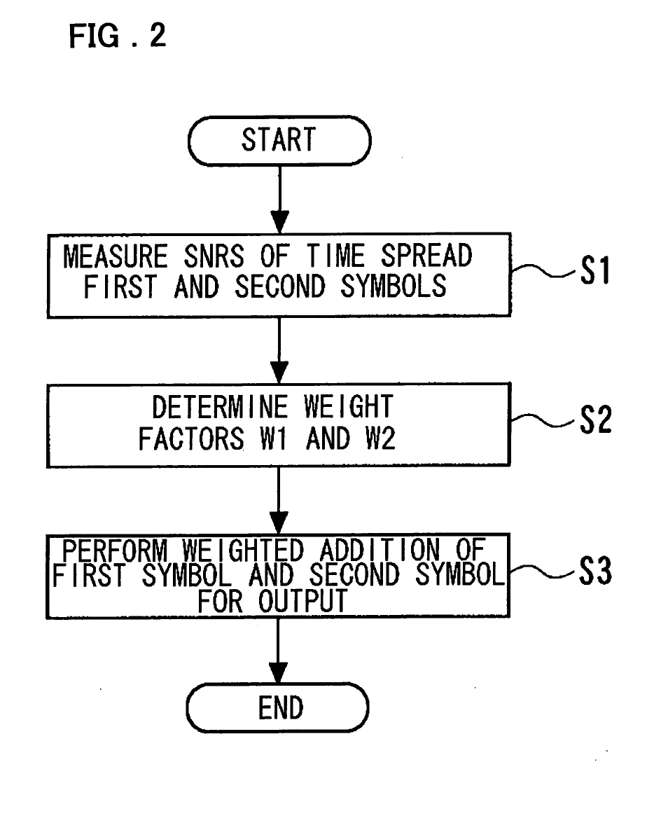

FIG. 2 is a flowchart for explaining a time despreading method according to the embodiment of the present invention. Referring to FIG. 2, the method according to the embodiment of the present invention will be described. First, the first and second symbols obtained by spreading of one symbol in time domain are received, and the measurement of reliability information of the received first and second symbols (such as signal qualities including the SNRs or the like) is carried out (at step S1).

Next, the weight factors W1 and W2 of the first and second symbols are derived from the measured values of the SNRs of the first and second symbols (at step S2).

Weighted addition of the first symbol and the second symbol is performed using the weight factors W1 and W2, respectively, thereby outputting one symbol (at step S3).

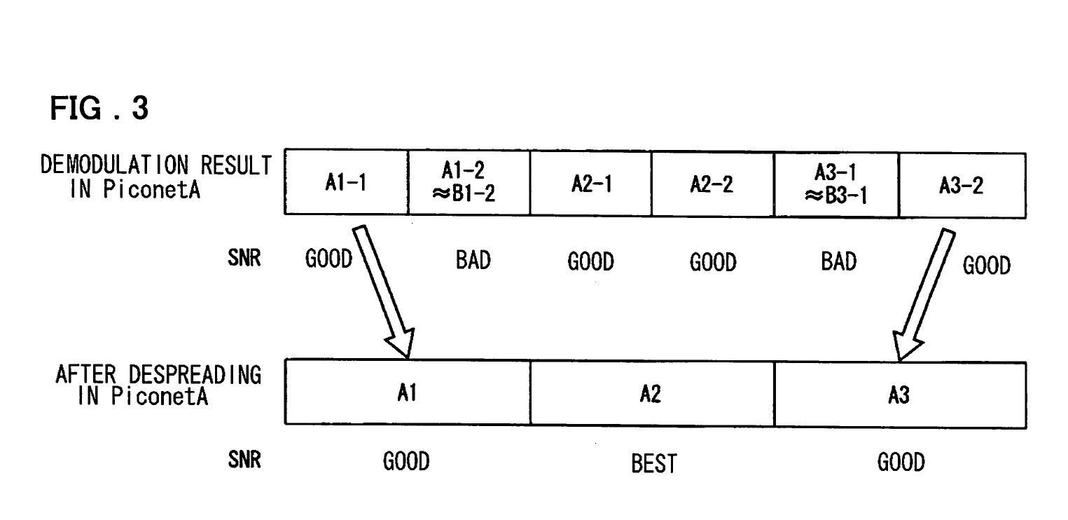

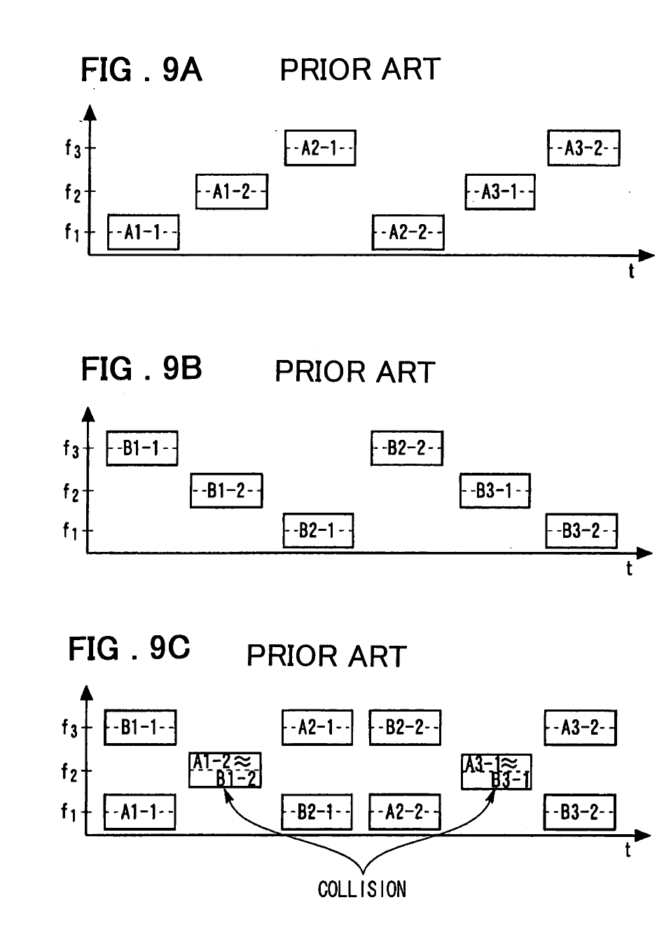

FIG. 3 is a diagram for explaining an operation and effect of the embodiment of the present invention. When the frequency hopping patterns in the piconet A in FIG. 9A collides with the frequency hopping patterns in the piconet B in FIG. 9B in the frequency band f2, as shown in FIG. 9C, weighted averaging is performed according to the weight factors determined based on the respective SNRs of the symbol A1-1 (with a good SNR) and the symbol A1-2 (that collides with the B1-2, so that the SNR is bad), thereby deriving the symbol A1 with the good SNR.

Likewise, by performing weighted averaging according to the weight factors determined based on the respective SNRs of the symbol A3-1 (the SNR of which is bad, because of collision with the B3-1) and the symbol A3-2 (with a good SNR), the symbol A3 with a good SNR is derived.

Further, by performing weighted averaging based on the respective SNRs of the symbol A2-1 (with a good SNR) and the symbol A2-2 (with a good SNR), the symbol A2 having the best SNR is derived.

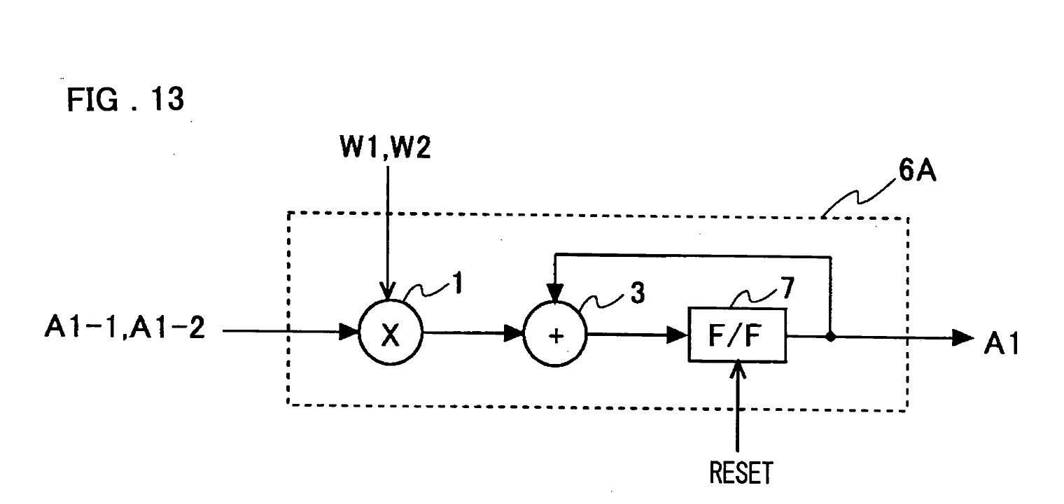

FIG. 13 is a diagram showing an example of a variation of the embodiment of the present invention in FIG. 1, and shows a variation example of a configuration of the combining circuit 6 in FIG. 1. This variation example is obtained by using a combining circuit 6A in FIG. 13 in place of the combining circuit 6 in the configuration in FIG. 1. Referring to FIG. 13, the combining circuit 6A includes one multiplier 1, the adder 3 for inputting the output of the multiplier 1 at a first input terminal thereof, and a flip-flop 7 for sampling the output of the adder 3 as an input. The output of the flip-flop 7 is connected to a second input terminal of the adder 3. Incidentally, referring to FIG. 13, the weight factors W1 and W2 are supplied from the weight determination circuit 5.

Next, an operation of the combining circuit 6A shown in FIG. 13 will be described. At the time of the start of combining the symbols, the flip-flop 7 is reset by a reset signal, so that its output is brought to zero. The multiplier 1 supplies the result of multiplication of the symbol A1-1 by the weight factor W1 to the first input terminal of the adder 3. The adder 3 adds the result of multiplication of the symbol A1-1 by the corresponding weight factor W1 to the input value zero to the second input terminal (the output of the flip-flop 7), and supplies the result of addition to the flip-flop 7. Next, the multiplier 1 supplies the result of multiplication of the symbol A1-2 by the corresponding weight factor W2 to the adder 3. The adder 3 adds the result of the multiplication of the symbol A1-2 by the weight factor W2 to the result of the multiplication of the symbol A1-1 by the weight factor W1 output from the flip-flop 7, and supplies the result of addition to the flip-flop 7. The result of the addition is output from the flip-flop 7 as the combined symbol A1.

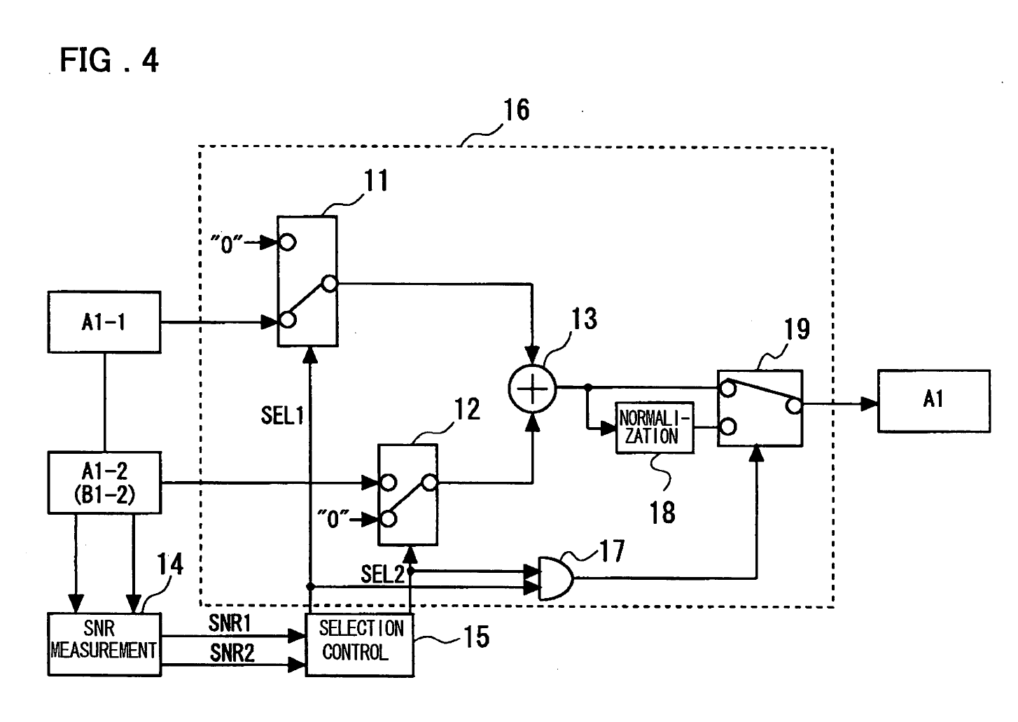

FIG. 4 is a diagram showing a configuration of other embodiment of the present invention. Referring to FIG. 4, this receiver includes a measurement circuit 14, a selection control circuit 15, and a combining circuit 16. The measurement circuit 14 obtains the reliability information (such as the SNRs) of the first and second symbols (A1-1, A1-2) spread in time domain with respect to one transmission symbol. The selection control circuit 15 generates first and second selection control signals (SEL1, SEL2) for controlling selections of the respective first and second symbols (A1-1, A1-2), based on the reliability information of the respective symbols obtained by the measurement circuit 14. The combining circuit 16 inputs the first and second symbols (A1-1, A1-2), and combines one symbols based on the first and second selection control signals (SEL1, SEL2), for output.

The combining circuit 16 includes a first selection circuit 11 for selecting one of the first symbol (A1-1) and a fixed value (=0) based on the first selection control signal (SEL 1), for output, a second selection circuit 12 for selecting one of the second symbol (A1-2) and the fixed value (=0) based on the second selection control signal (SEL 2), for output, an adder 13 for inputting the outputs of the first selection circuit 11 and the second selection circuit 12, a logic circuit 17 for inputting the first selection control signal and the second selection control signal (SEL1, SEL2), a normalization circuit 18 for halving the output of the adder 13, and a selection switch 19 for selecting one of the output signal of the adder 13 and the output signal of the normalization circuit 18, for output, based on the output signal of the logic circuit 17. The normalization circuit 18 is constituted from a one-bit shifting circuit when the output of the adder 13 is normalized by the halving, for example. The normalization circuit 18 is configured to be activated when upon receipt of the output signal of the logic circuit 17, the selection switch 19 selects the output of the normalization circuit 18 and configured to become inactive when upon receipt of the output signal of the logic circuit 17, the selection switch 19 selects the output of the adder 13. The normalization circuit 18 may also of course be configured to be operated only if necessary.

The first selection circuit 11 selects an input symbol or the fixed value (0) according to the first selection control signal (SEL1), and the second selection circuit 12 selects an input symbol or the fixed value (0) according to the second selection control signal (SEL2), for output. As a combination of the selection, one of following (i) through (iii), for example, is selected.

(i) The first and second symbols (A1-1, A1-2) are output from the first and second selection circuits 11 and 12, respectively, and the value in which the first and second symbols are added is output from the adder 13. The selection switch 19 selects the output of the normalization circuit 18 and outputs the result of weighted average of the first and second symbols (A1-1, A1-2). When the values of the first and second selection control signal (SEL1, SEL2) at the time of output of the first and second symbols (A1-1, A1-2) by the first and second selection circuits 11 and 12 outputs are (1, 1), the logic circuit 17 is constituted from an AND circuit, and the selection switch 19 selects the output of the normalization circuit 18 when the output from the logic circuit 17 is a logical 1.

(ii) The first symbol (A1-1) is output from the first selection circuit 11, the fixed value (0) is output from the second selection circuit 12, and the first symbol (A1-1) is output from the adder 13. The selection switch 19 selects the output of the adder 13, for output.

(iii) The second symbol (A1-2) is output from the second selection circuit 12, the fixed value (0) is output from the first selection circuit 11, and the second symbol (A1-2) is output from the adder 13. The selection switch 19 selects the output of the adder 13, for output.

Selection and output of the first symbol (A1-1) by the first selection circuit 11 in response to the first selection control signal SELL and selection and output of the fixed value 0 by the second selection circuit 12 in response to the second selection control signal SEL2 are functionally equivalent to setting of the weight factor W1 to one and setting of the weight factor W2 to zero in FIG. 1. However, according to the configuration shown in FIG. 4, by including the selection circuits 11 and 12 each constituted from a selection switch, the multipliers 1 and 2 needed in the configuration in FIG. 1 become unnecessary. For this reason, downsizing of the circuit configuration, reduction in the area of the circuit, and lower power dissipation can be achieved. A description will be given in connection with embodiments.

### First Embodiment

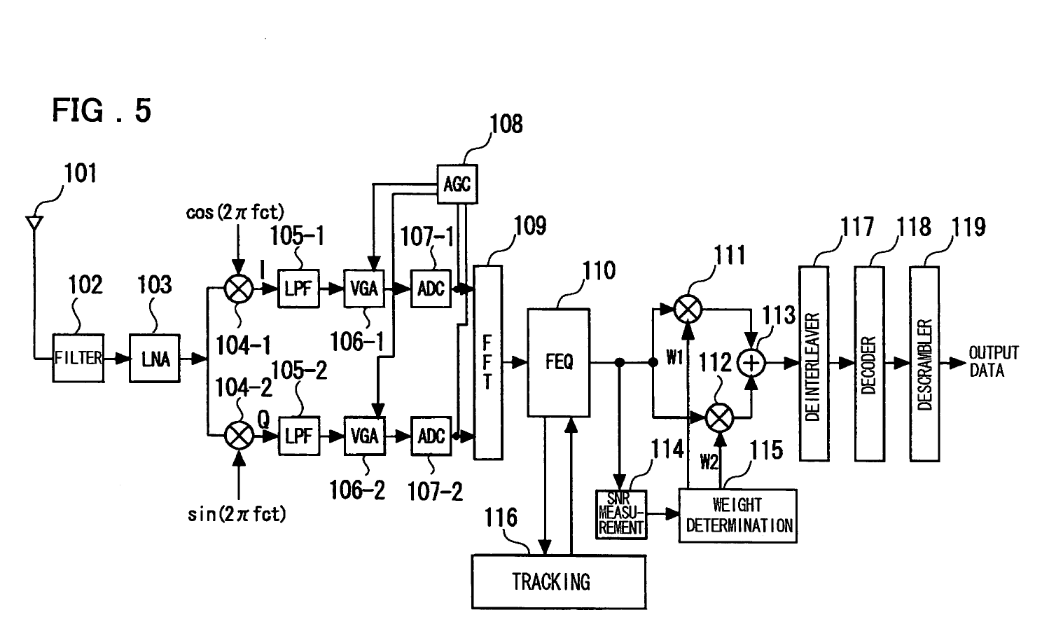

FIG. 5 is a diagram showing an example in which a time despreader according to the present invention, described with reference to FIG. 1 is applied to a multi-band OFDM (Orthogonal Frequency Division Multiplexing) receiver. Incidentally, as the configuration of the multi-band OFDM receiver, a 23 in the Non-patent Document 1 described above, for example, is referred to. Referring to FIG. 5, multipliers 111 and 112, an adder 113, an SNR measurement circuit 114, and a weight determination circuit 115 correspond to the multipliers 1 and 2, adder 3, SNR measurement circuit 4, and weight determination circuit 5 in FIG. 1, respectively. These five circuits constitute a time domain despreader in this embodiment. Referring to FIG. 5, a multi-band OFDM receiver will be outlined below.

A signal from an antenna 101 is selected by a filter 102, amplified by a low-noise amplifier (LNA) 103, and orthogonally demodulated by mixers 104-1 and 104-2 (a carrier frequency fc is switched in synchronization to a frequency hopping pattern on a transmitting side). Frequency components of an I (in-phase) signal and a Q (quadrature) signal orthogonally demodulated by the mixers 104-1 and 104-2 equal to or more than a cutoff frequency are removed by low pass filters (LPF) 105-1 and 105-2, respectively, and the resulting signals are amplified by variable gain amplifiers (VGA) 106-1 and 106-2, respectively. The components described above constitute an analog front end. The outputs of the variable gain amplifier (VGA) 106-1 and 106-2 are converted to digital signals (complex digital baseband signals) by analog digital converters (ADC) 107-1 and 107-2, respectively. The outputs of the analog digital converters (ADC) 107-1 and 107-2 are supplied to an automatic gain control circuit (AGC) 108. The automatic gain control circuit (AGC) 108 adjusts and controls the gains of the variable gain amplifiers (ADCs) 106-1 and 106-2. After CPs (Cyclic Prefixs) are removed from the digital signals output from the analog digital converters (ADCs) 107-1 and 107-2, conversion from serial data to parallel data is performed. The parallel data are input to an N-point (N being 128, for example) fast Fourier transform (FFT) unit 109, for demodulation, so that a data symbol (OFDM symbol) of each sub carrier Yₖ (k=0 to N−1) is output. The data symbol Yₖ of each subcarrier output from the fast Fourier transform (FFT) unit 109 is input to a frequency domain equalization (FEQ) circuit 110, and the influence of a channel (a transmission channel) is removed by equalization.

The frequency domain equalization (FEQ) circuit 110 will be outlined below. A tap coefficient (compensating coefficient) Ck is determined by the following equation (1) from a transmitted training symbol (to be normally inserted into a preamble section) Bₖ and its received symbol Yₖ.
Cₖ=Bₖ/Yₖ (in which k=0^{˜}N−1) (1)
in which 1/Cₖ (which is a complex coefficient for compensating for the amplitude and phase of the data symbol of each subcarrier) is the coefficient that approximates the transfer function of the channel (transmission channel).

The frequency domain equalization (FEQ) 110 outputs a value obtained by multiplying the data symbol Yₖ for each subcarrier output from the fast Fourier transform (FFT) unit 109 by the compensating coefficient Cₖ.
Y′ₖ=Cₖ*Yₖ (where k=0^{˜}N−1) (2)

A tracking unit 116 estimates a phase error from a pilot subcarrier in the symbol, for correction.

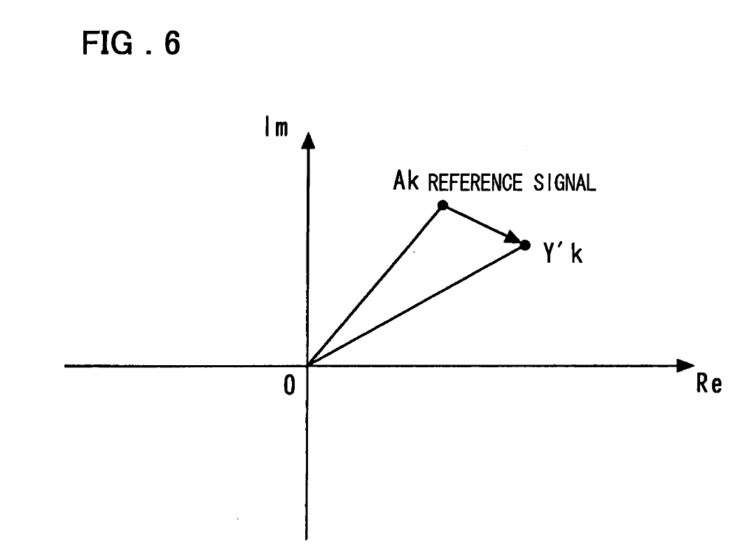

The SNR measurement circuit 114 receives the data symbol Y′ₖ of each subcarrier output from the frequency domain equalization (FEQ) circuit 110, and as shown in FIG. 6, an error vector Y′ₖ-Aₖ is obtained from the Y′ₖ and a reference signal (Aₖ) on a complex plane (an IQ plane). The average of squares (mean squares) obtained by adding the total sum of the squares of the error vectors for the respective subcarriers Y′k and dividing the total sum by N is obtained, and this is set to noise power N_{AV}.

$${N}_{AV} = \frac{1}{N} {\sum }_{k = 0}^{N - 1} {\vert {Y}^{′} k - Ak \vert}^{2} \qquad ( 3 )$$

Then, the average of the squares of the reference signals (Aₖ) of the respective subcarriers is set to power S_{AV}.

$${S}_{AV} = \frac{1}{N} {\sum }_{k = 0}^{N - 1} {\vert Ak \vert}^{2} \qquad ( 4 )$$

Further, the SNR is determined from the above equations (3) and (4) using the following equation (5).
SNR=10×log(S_{AV}/N_{AV}) (5)

In the above equations (3) and (4), for explanation of derivation of the average power, multiplication of (1/N) is performed on N_{AV} and S_{AV}. As seen from the following (5), (1/N) of the denominator N_{AV} and (1/N) of the numerator S_{AV} are canceled out when the SNR is derived. Thus, computation processing of the 1/N in the above equations (3) and (4) is not performed in an actual computation.

In this embodiment, a closest code point or an error corrected code point, for example, is employed as the reference signal.

The weight determination circuit 115 derives the weight factors W1 and W2 for two consecutive symbols from SNR1 and SNR2 of the two consecutive symbols spread in time domain. The ratio between the SNR1 and the SNR2 of the two symbols and the ratio between the weight factors W1 and W2, for example, may be set to be equal. In this case, the SNR1 and the SNR2 of the two symbols may be employed as the weight factors W1 and W2 without alteration. Alternatively, normalization may be performed so that W1+W2=1, for example, holds.

Alternatively, the weight determination circuit 115 may be configured to perform control so that when the SNR of one symbol of the two symbols despread in time domain is larger than the SNR of the other symbol by a predetermined value or more (or a difference between the SNRs is the predetermined value or more), the weight factor of the one symbol is set to 1, and the weight factor of the other symbol is set to 0. In this case, the weight factor zero for a multiplier means that the output of the multiplier is zero. Thus, the configuration in which the multipliers are omitted as shown in FIG. 4 may be employed. Further, the weight factor of one means that a signal input to the multiplier is output without alteration. The weight determination circuit 115 may be substituted for a switch in which an input symbol is passed through when the weight factor is one, and when the weight factor is zero, the passing is blocked (refer to the selection circuits 11 and 12 in FIG. 4). Incidentally, when a time spreading rate is three or more and among three or more symbols despread in time domain, an SNR difference between the symbol with the best SNR and other symbols is a predetermined value or more, the weight factor of the symbol with the best SNR may be set to one, while the weight factors for the other symbols may be set to zero.

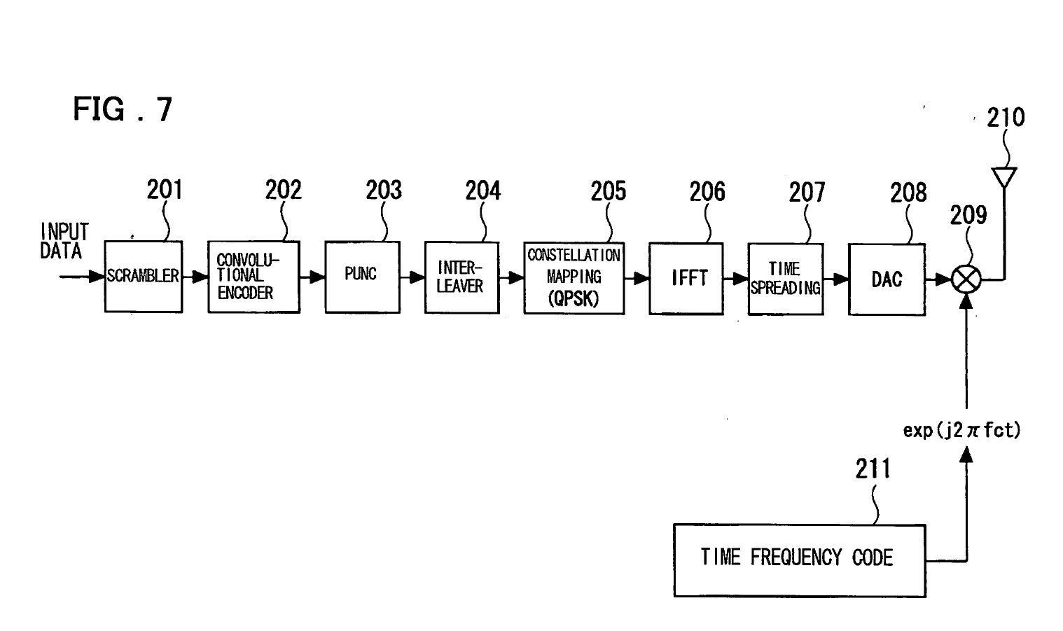

In a deinterleaver 117 that receives the output of the adder 113 in FIG. 5, exchange of bit codes associated with an interleaver on the transmitting side (refer to FIG. 7 that will be described later) is performed. The output of the deinterleaver 117 is input to a decoder 118 (which is a Viterbi decoder), for decoding. The decoder 118 uses a Viterbi algorithm to perform processing of most likelihood decoding. In this decoding, comparison among likelihoods of codewords in a received sequence that can be transmitted based on convolutional coding on the transmitting side is performed, and the most probable codeword that makes its likelihood maximum is selected. The signal decoded by the decoder 118 is then descrambled by a descrambler 119.

In this embodiment, a plurality of symbols are weighted and combined based on the measured values of the signal qualities of the plurality of symbols transmitted over different frequency bands using time spreading. Degrading of the signal qualities of the symbols obtained by time despreading is thereby prevented.

FIG. 7 is a diagram showing a configuration example of a transmitter for transmitting a multi-band OFDM signal to the receiver shown in FIG. 5 (refer to a slide 10 in Non-patent Document 1 described above, for example). Referring to FIG. 7, this transmitter will be outlined. A scrambler 201 performs randomizing processing on input data. A convolutional encoder 202 has a known configuration having a shift register and an mod-2 adder not shown, and performs encoding using an input bit and a value in the shift register (information in the past). A puncturer unit 203 erases some symbols of convolutional encoded data, thereby generating and outputting a code (a punctured code) with a higher code rate. A bit stream subject to the punctured encoding processing is buffered and block interleaved by an interleaver 204. Then, according to a constellation map such as QPSK (Quadrature Phase Shift Keying), a binary bit (two bits) is mapped to a QPSK signal. A pilot carrier is also inserted. Then, the QPSK signal is buffered, subject to an inverse fast Fourier transform by an N-point inverse fast Fourier transform unit (IFFT) 206, so that an OFDM symbol is generated. The OFDM symbol from the inverse fast Fourier transform unit 206 is time spread by a time spreading unit 207 (in which the same symbol is transmitted twice in the case of the time spreading rate of two, for example). Then, a parallel signal (the OFDM symbol) from the time spreading unit 207 is converted to a serial signal, to which a CP (Cyclic Prefix) is added, and is converted to an analog signal by a digital-to-analog converter 208. Then, according to a time frequency code 211 for determining the hopping pattern of a carrier frequency, a frequency synthesizer not shown outputs a carrier wave of which a frequency f has been hopped for each time corresponding to one symbol. A mixer 209 (a wireless unit), which inputs the analog signal from the digital-to-analog converter 208 and the carrier frequency (of the frequency fc) performs orthogonal modulation for combining and then output to the channel (transmission channel) from a transmitting antenna 210 through a power amplifier not shown. Arrangements of the inverse fast Fourier transform unit 206 and the time spreading unit 207 may be switched.

In the embodiment of the present invention, terminals that are ad hoc connected, for example, may include the receiver shown in FIG. 5 and the transmitter shown in FIG. 7.

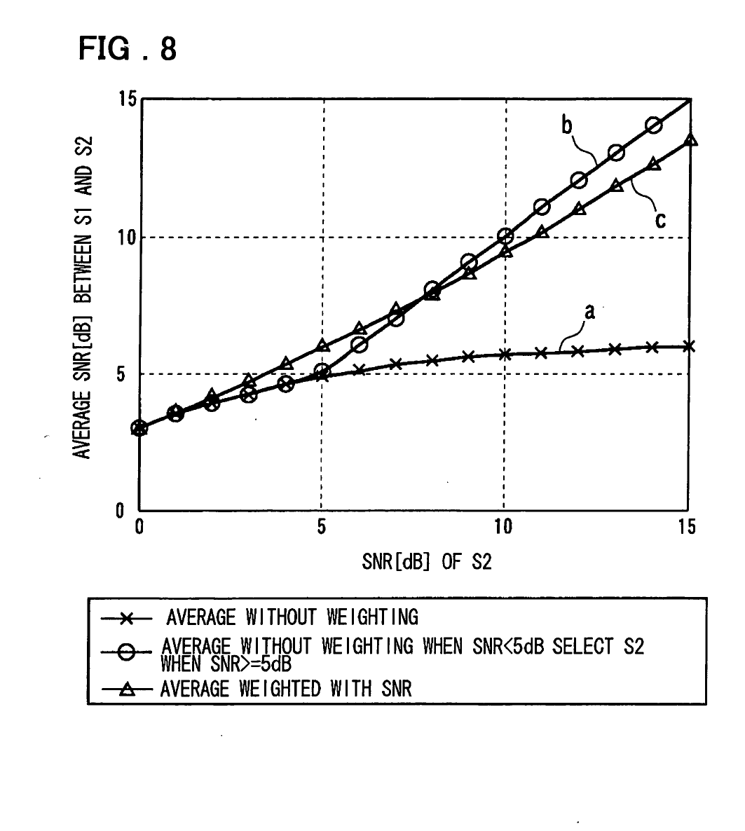

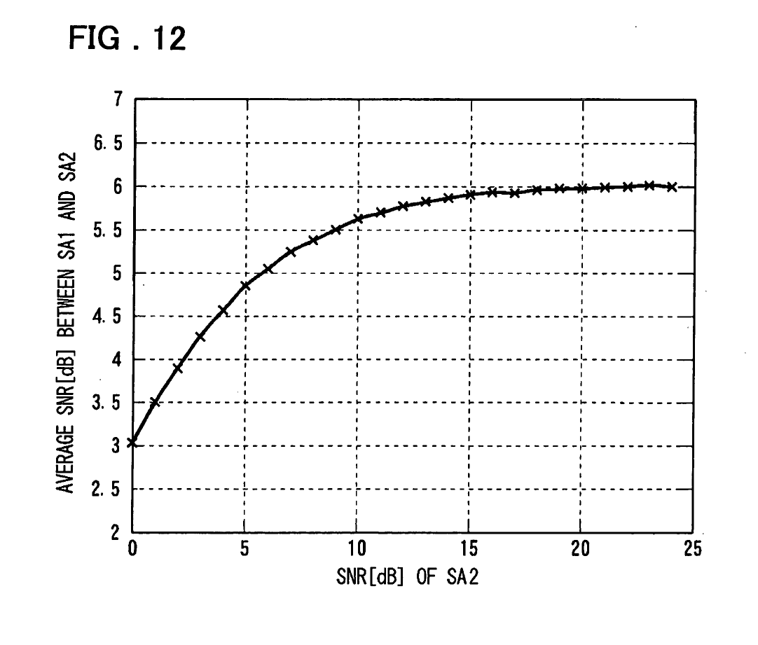

FIG. 8 is a diagram for explaining an operation and effect of the embodiment of the present invention. As in FIG. 12, this drawing is the diagram showing the SNR of a despread symbol (of S1+S2, as in FIG. 12) when two received symbols that have been time spread are set to S1 and S2 and the SNR of the symbol S2 has been changed from 0 dB to 15 dB with the SNR of the symbol S1 fixed at 0 dB. Incidentally, referring to FIG. 8, the SNR is given as 10×log(S_{AV}/N_{AV}) (in which S_{AV} indicates the average power of a signal while N_{AV} indicates the average power of noise).

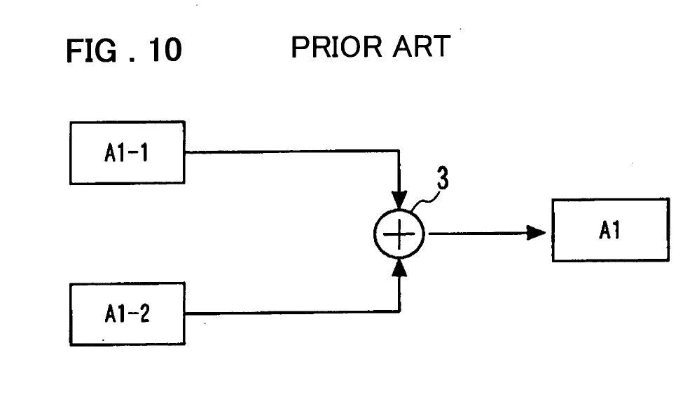

Referring to FIG. 8, a characteristic curve a connecting xs shows a case where averaging without the weighting shown in FIG. 10 is performed, as a comparative example, and corresponds to a characteristic curve in FIG. 12.

Referring to FIG. 8, a characteristic curve b connecting ◯s is in accordance with a time domain despreading circuit according to an embodiment of the present invention, shown in FIG. 4. When an SNR difference between the symbol S1 and the symbol S2 is 5 dB or less, averaging without weighting ((S1+S2)/2) is performed. When the SNR of the symbol S2 exceeds 5 dB, the symbol S2 is selected. As described above, when the SNR difference between the two received symbols is a predetermined value or more, the symbol with the better SNR is selected from the two symbols, for output. The SNRs of the time despread symbols are improved, corresponding to the SNR of the symbol with the better SNR. In this embodiment, the symbols S1 and S2 correspond to symbols A1-1 and A1-2 in FIG. 4, respectively. When a difference between the SNR 1 of the symbol A1-1 and the SNR 2 of the symbol A1-2 is the predetermined value or less (5 dB or less, for example), a selection control circuit 15 in FIG. 4 performs control so that selection circuits 11 and 12 selects both of the symbols A1-1 and A1-2 input thereto, for output. An adder 13 then performs addition of the symbol A1-1 and the symbol A1-2. A normalization circuit 18 normalizes the result of addition, for output. On the other hand, when the SNR 2 of the symbol A1-2 is larger than the SNR 1 of the symbol A1-1 and its difference is larger than the predetermined value (5 dB), the selection control circuit 15 performs control so that zero is selected by the selection circuit 11 and the symbol A1-2 is selected by the selection circuit 12. The adder 13 performs addition of the symbol A1-2 and zero, thereby outputting the symbol A1-2. Then, a selection switch 19 selects the output of the adder 13. On the contrary, when the SNR1 of the symbol A1-1 is larger than the SNR2 of the symbol A1-2 and its difference is larger than the predetermined value (5 dB), control is performed so that the symbol A1-1 is selected for output. When the time spreading rate is three or more and the maximum value of the SNR difference among the symbols is the predetermined value (5 dB or less, for example), averaging without weighting may be performed. Otherwise, the symbol with the best SNR may be selected.

Referring to FIG. 8, a characteristic curve c connecting Δs corresponds to the embodiment of the present invention shown in FIG. 1 and shows the SNR of a combined symbol with the weight factors W1 and W2 set to the values proportional to the SNR1 and the SNR2. In this embodiment, when the SNR 1 is set to zero and the SNR 2 is set to 7 dB or less, the characteristic curve c is better than the characteristic curves a and b. On the other hand, when the SNR 2 exceeds 7 dB, the characteristic curve b becomes better than the characteristic curve c.

Accordingly, control may be performed so that until a point of crossing between the characteristic curves b and c or when the SNR difference between the two symbols S2 and S1 is 7 dB or less, for example, weighting is performed according to the SNR associated with the characteristic curve c. When the SNR difference is 7 dB or more, control may be performed so that the weighting of the symbol with the better SNR is set to one, and the weighting of the other symbol is set to zero to implement the characteristic b and the best combining characteristic is thereby obtained.

In this embodiment, at least one of controls is performed in which:
(a) combining of symbols is performed at the one-to-one ratio of the weight factor W1 to the weight factor W2
(b) one of symbols is selected at the one-to-zero or zero-to-one ratio of the weight factor W1 to the weight factor W2
(c) weighting is performed at the ratio of the SNR1 the SNR2 which is the same as the ratio of the weight factor W1 to the weight factor W2
(d) switchover from the above-mentioned (a) to (c) is performed according to a difference between the SNR1 and the SNR2 that have been measured.

When the above-mentioned controls (a) and (b) are performed, multipliers in FIG. 1 will become unnecessary.

When the above-mentioned controls (b) and (c) are combined, the characteristics c and b in FIG. 8 are selected. The optimum combining can be thereby implemented.

Further, one of the symbols with the best SNR may be selected, based on the SNRs of a plurality of symbols that have been time spread. When signal quality of one of the SNRs of the first symbol A1-1 and the second A1-2 is larger than the predetermined value, for example, it may be so configured that the one symbol is selected for output. In this case, the SNR difference between the first symbol A1-1 and the second symbol A1-2 is not calculated. When the values of the SNRs are the predetermined value or more, reliability of the transmission channel is determined to be sufficiently high, and one of the weight factors W1 and W2 in FIG. 1 is set to one and the other is set to zero. Alternatively, one of selection control signals SEL1 and SEL2 in FIG. 4 is set to one, and the other is set to zero.

In this embodiment, the SNR used as the reliability information of a received symbol sequence is measured using the average powers of noise and a signal. The SNR may be determined based on the peak levels of the noise and the signal. Alternatively, a noise power level or the like may be employed as the reliability information of the received symbol sequence. Further, when an inter-symbol interference (ISI) becomes a problem due to frequency selective fading or the like, an interference level may be obtained and the weight factor may be determined. Alternatively, through statistical processing using an MA (Moving Average) model or the like, the weight factor calculated from the reliability information of a received symbol may be of course anticipated and estimated, and adjusted and controlled in real time so that a combined symbol error (a square error) is minimized. In the present invention, as the reliability information of the received symbol sequence, determination as to whether the reliability of a received symbol is high or low (therefore the badness of a communication environment about the transmission channel) should only be determined, and therefore arbitrary information other than the above-mentioned SNR (such as error information or offline information) may be of course employed.

According to this embodiment, in addition to the case where carrier frequency hopping patterns collide with each other between the piconets, even when a frequency band used by other device has become an interference wave for a certain device so that the SNR of that frequency band deteriorates, it becomes possible to make the SNR of a symbol that has been time despread to be satisfactory. Further, even when the SNR of a symbol has deteriorated due to frequency fading, the estimated error of a compensating coefficient for the FEQ, or the like, it becomes possible to make the SNR of the symbol that has been time despread to be satisfactory.

The present invention is not applied to only a WPAN device or the like, but is applied to an arbitrary communication system in which an information symbol is time spread and then transmitted as a plurality of symbols.

Though a description was given about the present invention in connection with the embodiments described above, the present invention is not limited to only the embodiments described above. The invention of course includes various variations and modifications that could be made by those skilled in the art within the scope of the present invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

1. A receiver comprising:
a receiving circuit for receiving a plurality of symbols sent from a transmitter which executes, for information transmission, spreading of one symbol in time domain to obtain said plurality of symbols; and
a time domain despreading circuit for deriving weight factors for the plurality of symbols received based on respective reliability information of the plurality of symbols, and combining the plurality of symbols into one symbol based on the weight factors to output the combined one symbol.

2. The receiver according to claim 1, wherein the plurality of symbols are sequentially transmitted on a transmission channel from the transmitter transmitting the plurality of symbols by switching carrier frequencies in accordance with a predetermined hopping pattern; and
wherein said receiver switching a local oscillation frequency thereof in association with the hopping pattern used by said transmitter to perform demodulation.

3. The receiver according to claim 1, wherein said time domain despreading circuit comprises:
a measurement circuit for measuring the respective reliability information of the plurality of symbols;
a weight determination circuit for receiving the respective reliability information of the plurality of symbols to determine the weight factors for the plurality of symbols; and
a combining circuit for performing combination into the one symbol, for output, based on the plurality of symbols and the weight factors for the plurality of symbols.

4. The receiver according to claim 3, wherein said weight determination circuit determines the weight factors for the plurality of symbols so that reliability information of the combined one symbol obtained by said combining circuit becomes best.

5. The receiver according to claim 3, wherein said measurement circuit measures respective signal qualities of the plurality of symbols as the respective reliability information of the plurality of symbols.

6. The receiver according to claim 3, wherein said combining circuit comprises:
at least one multiplier for receiving each of the plurality of symbols and each of the weight factors from said weight determination circuit to multiply said each of the input symbols by said each of the weight factors corresponding to the symbols; and
an adder for receiving a result of the multiplication by said multiplier, for addition, and outputting a result of the addition as the combined one symbol.

7. The receiver according to claim 5, wherein said weight determination circuit sets the weight factors for the plurality of symbols to values proportional to measurement values of the signal qualities of the plurality of symbols.

8. The receiver according to claim 5, wherein said weight determination circuit sets the respective weight factors for the plurality of symbols, so that when a difference of the signal quality measurement value of at least one of the plurality of symbols and the signal quality measurement values of other ones of the plurality of symbols is a predetermined value or more in view of a magnitude relation among the signal quality measurement values of the plurality of symbols, said at least one of the plurality of symbols is selected, and the other ones of the plurality of symbols other than the selected symbol are not selected.

9. The receiver according to claim 5, wherein when a difference between the signal quality measurement values of two of the plurality of symbols is less than the predetermined value or when a number of the plurality of symbols is two or more and a maximum value of differences among the signal quality measurement values of the plurality of symbols is less than the predetermined value in view of the magnitude relation among the signal quality measurement values of the plurality of symbols, said weight determination circuit sets the weight factors for the respective symbols to values proportional to the signal quality measurement values of the respective symbols.

10. The receiver according to claim 5, wherein when a difference between the signal quality measurement values of two of the plurality of symbols is less than a predetermined value, or when a number of the plurality of symbols is two or more and a maximum value of differences among the signal quality measurement values of the plurality of symbols is less than the predetermined value in view of a magnitude relation among the signal quality measurement values of the plurality of symbols, said weight determination circuit sets the weight factors for the plurality of symbols to be equal.

11. The receiver according to claim 5, wherein said weight determination circuit sets the respective weight factors for the plurality of symbols so that when a difference between signal quality measurement values of at least one of the plurality of symbols and other ones of the plurality of symbols is a predetermined value or more, in view of a magnitude relation among the signal quality measurement values of the plurality of symbols, said at least one of the plurality of symbols is selected, and said other ones of the plurality of symbols other than the selected symbol are not selected; and
when a difference between the signal quality measurement values of two of the plurality of symbols is less than the predetermined value or when a number of the plurality of symbols is two or more and a maximum value of differences among the signal quality measurement values of the plurality of symbols is less than the predetermined value, said weight determination circuit sets the weight factors for the plurality of symbols to be equal.

12. A receiver comprising:
a circuit for receiving a plurality of symbols sent from a transmitter, which executes, for information transmission, spreading of one symbol in time domain to obtain said plurality of symbols; and
a time domain despreading circuit for selecting at least one of the plurality of symbols received based on respective reliability information of the received plurality of symbols, and outputting the one symbol selected from among the plurality of symbols.

13. The receiver according to claim 12, wherein the plurality of symbols are sequentially transmitted on a transmission channel from the transmitter transmitting the plurality of symbols by switching carrier frequencies in accordance with a predetermined hopping pattern; and
wherein said receiver switches a local oscillation frequency thereof in association with the hopping pattern used by said transmitter to perform demodulation.

14. The receiver according to claim 12, wherein said time domain despreading circuit comprises:
a measurement circuit for measuring the respective reliability information of the plurality of symbols;
a selection control circuit for receiving the respective reliability information of the plurality of symbols and outputting selection control signals for controlling selection or non-selection of the respective plurality of symbols;
a plurality of selection switches for performing switching control of selection or non-selection of the respective plurality of symbols based on the selection control signals for the respective plurality of symbols; and
an addition circuit for performing addition in regard to the plurality of selection switches to output one symbol.

15. The receiver according to claim 14, wherein said measurement circuit measures respective signal qualities of the plurality of symbols as the respective reliability information of the plurality of symbols.

16. The receiver according to claim 5, wherein the signal quality measurement values of the plurality of symbols comprises signal to noise ratios of the plurality of symbols.

17. The receiver according to claim 16, comprising at least:
a wireless unit for receiving and demodulating a multi-band OFDM (Orthogonal Frequency Division Multiplexing) signal, with said multi-band OFDM the plurality of symbols being transmitted by hopping carrier frequencies using a predetermined pattern, for information transmission, in an orthogonal frequency multiplexing (OFDM) manner in which frequencies of a plurality of subcarriers are orthogonal to one another;
an analog-to-digital converting circuit for receiving an analog signal from said wireless unit to convert the analog signal to a digital signal;
a Fourier transform unit for receiving from an output of said analog-to-digital converting circuit, a signal with a predetermined prefix removed therefrom to perform Fourier transformation of the signal received; and
an equalizer for receiving a signal output from said Fourier transform unit to perform equalization of the signal received in frequency domain;
wherein said measurement circuit calculates an average of squares of errors of data symbols for respective subcarriers, output from said equalizer to determine a signal-to-noise ratio of each of the symbols.

18. The receiver according to claim 17, wherein said measurement circuit obtains squares of absolute values of error vectors between the data symbols for the respective subcarriers obtained from said equalizer and corresponding reference signals, and determines the signal to noise ratio from a ratio of an average of squares of the reference signals for the respective subcarriers to an average of squares obtained by dividing a total sum of the squares of the absolute values for the subcarriers by a number of the subcarriers.

19. A communication system comprising:
a transmitter for transmitting a plurality of symbols obtained by time spreading one symbol in time domain for information transmission; and
the receiver as defined in claim 1.

20. A portable communication terminal comprising:
a transmitter for transmitting a plurality of symbols obtained by time spreading one symbol in time domain, for information transmission; and
the receiver as defined in claim 1.

21. A receiving method for receiving a plurality of symbols corresponding to one symbol and sent from a transmitting side which executes, for information transmission, spreading of the one symbol in time domain to obtain said plurality of symbols, said method comprising:
obtaining reliability information of the plurality of symbols;
determining respective weight factors for the plurality of symbols based on the reliability information of the plurality of symbols; and
combining the plurality of symbols into one symbol based on the weight factors corresponding to the respective plurality of symbols, for output.

22. The receiving method according to claim 21, wherein the weight factors for the plurality of symbols are set so that reliability information of the one symbol obtained by combining the plurality of symbols becomes best.

23. A receiving method for receiving a plurality of symbols corresponding to one symbol and sent from a transmitting side which executes, for information transmission, spreading of the one symbol in time domain to obtain said plurality of symbols, said method comprising:
obtaining reliability information of the plurality of symbols; and
selecting at least one of the plurality of symbols based on the reliability information of the plurality of symbols, and outputting the selected one symbol from among the plurality of symbols.

24. The receiving method according to claim 21, wherein the plurality of symbols are sequentially sent from the transmitter on a transmission channel by switching carrier frequencies in accordance with a predetermined hopping pattern.
